(19) United States
(12) Patent Application Publication
(10) Pub. No.: US 2002/0096953 A1
(43) Pub. Date: Jul. 25, 2002

(54) Method of molding a bearing housing and motor using the bearing housing

(76) Inventors: Hiroyuki Shingai, Tokyo (JP); Yasuo Shibata, Tokyo (JP)

Correspondence Address: McGinn & Gibb, PLLC, Suite 200, 8321 Old Courthouse Road, Vienna, VA, 22182-3817, US

(21) Appl. No.: 10/053,771

(22) Filed: Jan. 24, 2002

(30) Foreign Application Priority Data
Jan. 25, 2001 (JP) P2001-017199

(51) Int. Cl. H02K 5/16; H02K 7/08

(52) U.S. Cl. 310/90

(57) ABSTRACT

A first cavity portion (103) for molding a first inner peripheral surface which is molded continuously from an opening of a bearing hole portion is provided in a first mold block (101). In a second mold block (102), a cavity C having an outside diameter (d2) greater than an inside diameter (d1) of the first peripheral surface and formed by the first cavity portion (103) and a second cavity portion at the time of mold closing is coaxially positioned, and a plurality of shape portions (104) for forming stepped portions are provided in such a manner as to extend toward the first mold block. A predetermined resin material in a molten state is introduced into the cavity to effect molding.

### BACKGROUND OF THE INVENTION

The present invention relates to a method of molding a bearing housing and a motor using the bearing housing, and concerns a technique which is applicable to, for instance, a compact fan motor.

Generally, fan motor which is constructed such that a motor rotor in which a rotating member including vanes is fixed to a motor shaft is supported by a bearing of a bearing housing having a stator have been put to practical use.

According to the fan motors, there are a type in which the bearing is a metal bearing including an oil-retaining sintered metal bearing, a type in which the bearing is a radial ball bearing, and a type in which the metal bearing and the radial ball bearing are used in combination. The metal bearing and the radial ball bearing are arranged to be supported and immovably fixed at a stepped portion molded annularly at an inner peripheral surface of a bearing hole portion of a bearing housing which is injection molded of a predetermined resin material.

Specifically, the stepped portion for effecting the positioning of the bearing is molded annularly in advance at the inner peripheral surface of the bearing hole portion of the bearing housing. After the metal bearing and the radial ball bearing are inserted from both sides of the bearing hole portion, the rotor is axially supported, thereby completing the assembly.

When such an annular stepped portion is molded, in order to ensure coaxiality, a conical projecting portion and a conical recessed portion for fitting to the projecting portion are formed to mating faces at a parting line of upper and lower molded halves. Therefore, the coaxiality can be ensured by fitting the conical projecting in the conical recessed portion at the time of mold closing. Meanwhile, a cavity portion for molding the aforementioned annular stepped portion is provided in advance at a proximal portion of the conical projecting portion, thereby molding the bearing housing. Alternatively, the coaxiality is ensured by providing positioning pins to the upper and lower mold halves to mold coaxiality.

However, according to the mold having the above-described construction, due to the variation of machining occurring in the mating faces of the upper and lower mold halves, as to the accuracy of coaxiality when the upper and lower mold halves are fitted at the time of the mold closing, a maximum of two-fold deviation of coaxiality occurs as compared with an integrated type in which a cavity for molding the bearing hole portion for fitting both the metal bearing and the radial ball bearing is formed in the same mold. In addition, when injection molding is effected, there are cases where small deviations in fitting and wear are liable to occur due to each fitting of the upper and lower mold halves. Further, since the annular stepped portion is continuously formed over the entire periphery of the bearing hole portion, there are cases where axes of the bearings which are inserted from both sides of the stepped portion are difficult to be aligned.

### SUMMARY OF THE INVENTION

Accordingly, the invention has been devised in view of the above-described circumstances, and its object is to provide a method of molding a bearing housing which makes it possible to support a bearing at the same inner peripheral surface in a bearing hole portion of the bearing housing by ensuring coaxiality of an injection mold when, for example, two bearings are inserted and fixed with stepped portions interposed therebetween, as well as a motor using the bearing housing.

In order to solve the aforesaid object, the invention is characterized by having the following arrangement.

(1) A method of molding a bearing housing, for axially supporting a motor rotor, having stepped portions midway on an inner peripheral surface of a bearing hole portion, wherein the bearing housing is injection molded from a predetermined resin material, the method comprising the steps of:

providing in a first mold block a first cavity portion for molding a first inner peripheral surface which is molded continuously from an opening of the beating hole portion;

providing in a second mold block a second cavity portion and a plurality of shape portions, for forming the stepped portions, each of which has an outside diameter greater than an inside diameter of the first inner peripheral surface and extends toward the first mold block, wherein the first cavity portion and the second cavity portion forming a cavity at the time of mold closing is coaxially positioned; and

introducing the predetermined resin material in a molten state into the cavity to effect molding.

(2) A motor having a bearing housing obtained by a method as claimed in (1).

(3) The motor according to (2), wherein at least one of a metal bearing and a radial ball bearing is supported by the plurality of stepped portions.

(4) The motor according to (3), wherein the stepped portion supports both of the metal beating and the ball bearing.

(5) The motor according to (3), wherein the metal bearing is provided with a recessed portion for escaping from the stepped portion.

(6) The motor according to (4), wherein the metal bearing is an oil-retaining sintered metal bearing.

(7) A mold for molding a bearing housing, for axially supporting a motor rotor, having stepped portions molded midway on an inner peripheral surface of a bearing hole portion, wherein the beading housing is injection molded from a predetermined resin material, the mold comprising:

a first mold block provided with a first cavity portion for molding a first inner peripheral surface which is molded continuously from an opening of the bearing hole portion; and

a second mold block provided with a second cavity portion and a plurality of shape portions, for forming the stepped portions, each of which has an outside diameter greater than an inside diameter of the first inner peripheral surface and extends toward the first mold block, wherein the first cavity portion and the second cavity portion forming a cavity at the time of mold closing is coaxially positioned.

(8) A motor comprising:

at least one bearing for supporting a motor shaft of a motor rotor;

a housing provided with a bearing hole portion into which the bearing is inserted; and

a stepped portion, for supporting the at least one bearing, which is provided at a part of the inner circumference of the bearing hole portion and has a diameter smaller than an inner diameter of the bearing hole portion.

### BRIEF DESCRIPTION OF THE DRAWINGS

FIG. 1A is a central cross-sectional view illustrating a state in which a mold for a bearing housing is closed;

FIG. 1B is a cross-sectional view taken in the direction of arrows along line X-X in FIG. 1A;

FIG. 2A is an external perspective view illustrating a state in which the mold shown in FIGS. 1A and 1B is in an open state;

FIG. 2B is an external perspective view illustrating a state in which the mold is in a closed state;

FIG. 3 is an external perspective view, partially cutaway, of a bearing housing 1 molded by using the mold;

FIG. 4A is a central cross-sectional view of a first embodiment in a case where the bearing housing is applied to a brushless axial fan motor;

FIG. 4B is an exploded view of component parts shown in FIG. 4A;

FIG. 5A is a central cross-sectional view of a second embodiment in a case where the bearing housing is applied to a brushless axial fan motor; and

FIG. 5B is an exploded view of component parts shown in FIG. 5A.

### DETAILED DESCRIPTION OF PREFERRED EMBODIMENTS FIRST EMBODIMENT

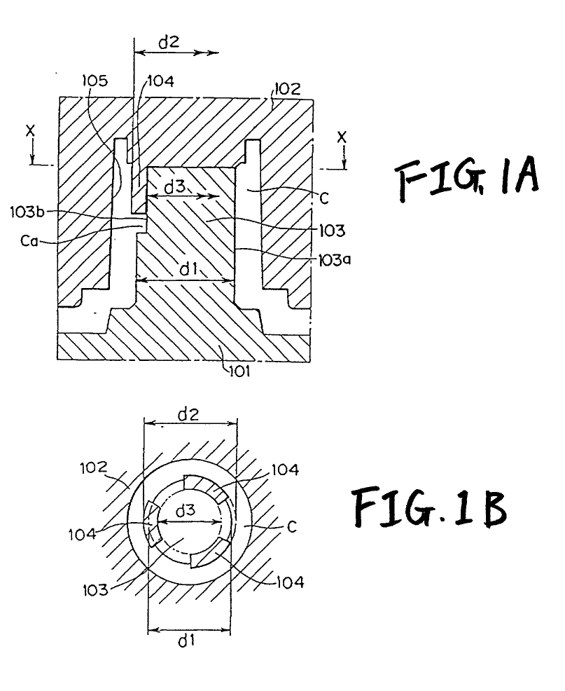

Referring now to the accompanying drawings, a description will be given of a preferred embodiment of the invention. FIG. 1A is a central cross-sectional view illustrating a state in which a mold for a bearing housing is closed, and FIG. 1B is a cross-sectional view taken in the direction of arrows along line X-X in FIG. 1A.

In FIG. 1A, molten resin material is injected under a high pressure and at a high speed into a cavity C having a cross-sectional shape illustrated in the drawing, the mold is subsequently opened after curing, and the molded bearing housing is removed to outside, so that the bearing housing is inject molded from a predetermined resin material. A first cavity portion 103 is formed on a first mold block 101 for forming the cavity C. The first cavity portion 103 is a cylindrical shape in which an outer peripheral surface 103a for molding a first inner peripheral surface is formed with an outside diameter d1. The first inner peripheral surface is molded continuously from an opening of the bearing hole portion of the bearing housing to be described later.

Three recessed portions having bottom portions 103b with an outside diameter d3 smaller than the aforementioned outside diameter d1 are formed in the first cavity portion 103 at equiangular intervals of 120 degrees, as shown in FIG. 1B.

A second cavity portion 105 for forming the cavity in cooperation with the first cavity portion 103 at the time of mold closing is formed in a second mold block 102. Three shape portions 104 having an outside diameter d2 greater than the inside diameter d1 for molding the aforementioned first inner peripheral surface and having an inside diameter d3 conforming to the bottom portions 103b are integrally provided on this second mold block 102.

Each of these shape portions 104 has a depth shallower than the depth of the recessed portion having the aforementioned bottom portion 103b so as to form a stepped portion cavity Ca for molding the stepped portion of the bearing housing, as shown in FIG. 1A.

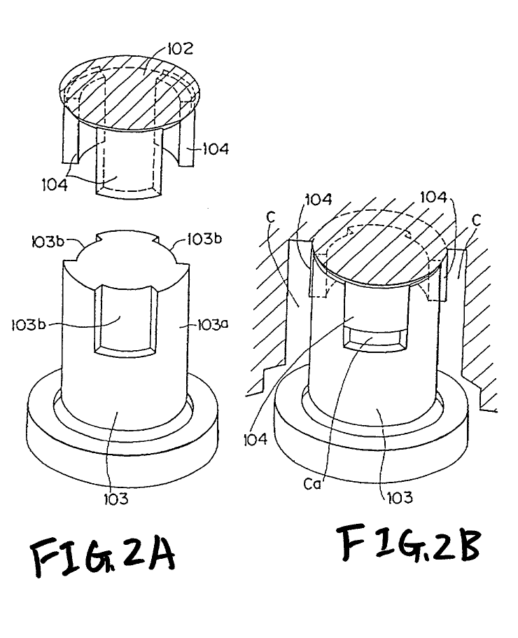

Next, FIG. 2A is an external perspective view illustrating a state in which the mold shown in FIGS. 1A and 1B is in an open state, and FIG. 2B is an external perspective view illustrating a state in which the mold is in a closed state.

In the drawings, the component parts which have already been described are denoted by the same reference numerals, and a description thereof will be omitted. In FIG. 2A, the three shape portions 104 are formed in such a manner as to project downward from the second mold block 102 illustrated by hatching, and are arranged to be fitted to the bottom portions 103b of the recessed portions formed in the first cavity portion 103 of the first mold block 101. In FIG. 2B, the aforementioned stepped portion cavity Ca is formed when the mold is closed.

A predetermined resin material in a molten state is introduced into the cavity C and the stepped portion cavity Ca of the mold constructed as described above through a gate and runners which are not shown. When the mold is opened after curing and the molded piece is removed, the bearing housing can be obtained.

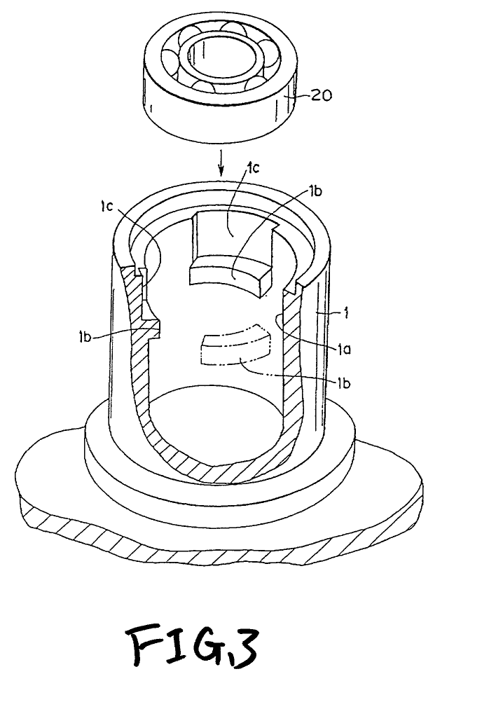

FIG. 3 is an external perspective view, partially cutaway, of a bearing housing 1 molded by using the above-described mold. In the drawing, three stepped portions 1b are molded midway on an inner peripheral surface of a bearing hole portion 1a of the bearing housing 1. Recessed portions 1c having the outside diameter d2 are formed upwardly of these stepped portions 1b. These recessed portions 1c do not have the function of supporting the outer peripheral surface of the bearing.

A radial ball bearing 20 is set at the three stepped portions 1b of the bearing housing 1 thus molded, and an oil-retaining sintered metal bearing 5, which will be described later, is set therein from below. When the two bearings are thus inserted and fixed with the stepped portions placed therebetween, since the bearing hole portion 1a is molded by the outer peripheral surface 103a of the same cavity portion 103, the bearing housing 1 is able to ensure coaxiality with respect to the outer peripheral surfaces of the respective bearings.

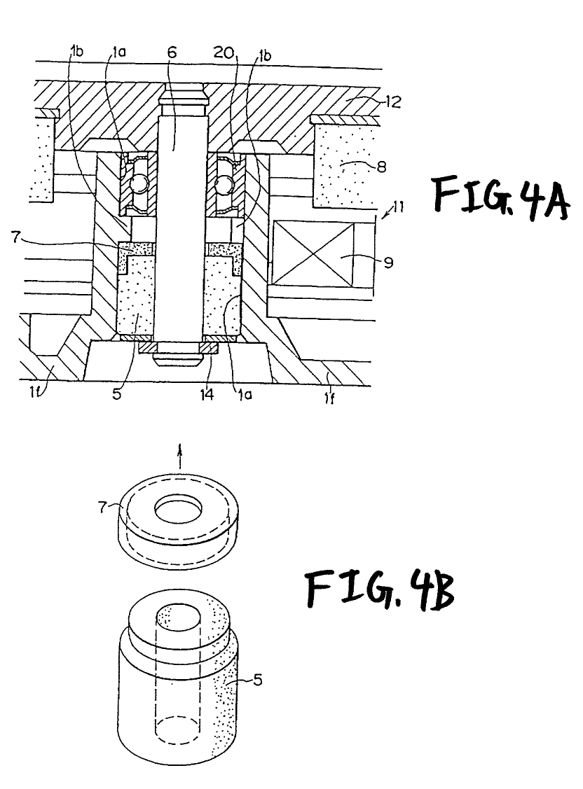

FIG. 4A is a central cross-sectional view of a first embodiment in a case where the bearing housing obtained as described above is applied to a brushless axial fan motor. FIG. 4B is an exploded view of component parts.

In the drawings, the bearing housing 1 is injection molded by using as a material a glass-containing resin material obtained by mixing ABS resin and polybutylene terephthalate resin at a predetermined weight ratio, or a predetermined resin material such as noryl resin or polypropylene resin. In this bearing housing 1, an unillustrated frame portion is formed via supporting rods If continuously from a hollow cylindrical basal portion where the bearing hole portion 1a is formed. The arrangement provided is such that air is supplied through unillustrated openings between adjacent ones of the supporting rods 1f.

The oil-retaining sintered metal bearing 5 for axially supporting a motor shaft 6 rotatably, after being covered with a cap member 7 as shown in FIG. 4B, is set in the bearing hole portion 1a in such a manner as to abut against the stepped portions 1b. Meanwhile, the radial ball bearing 20 having a long continuous endurance time is set as described with reference to FIG. 3. The cap member 7 has such a shape as to wrap up an outer periphery of the oil-retaining sintered metal bearing 5 so as to prevent the impregnating oil from leaking to the stepped portion side. By virtue of the above-described construction, the motor shaft 6 is axially supported by both the metal bearing 5 and the radial ball bearing 20.

On the other hand, a stator 11 formed by winding a coil 9 on a substrate is fixed to the bearing housing 1 by a method including bonding in the illustrated manner.

A magnetic variation of an annular permanent magnet 8 multipolarized and fixed to a motor rotor 12 with the motor shaft 6 insert molded therein is detected by an unillustrated Hall element, and the coil 9 is energized on the basis of the detected result to generate a rotating magnetic field, thereby forming a brushless motor in which the motor rotor 12 is magnetically attracted and is rotatively driven. The motor rotor 12 is axially supported rotatably by the oil-retaining sintered metal bearing 5 and the radial ball bearing 20 as described above, while the motor shaft 6 is fabricated from, for example, a stainless steel rod member.

Meanwhile, a plurality of unillustrated vane portions are molded integrally with the motor rotor 12 on a side located further outwardly of the outer periphery of the permanent magnet 8 which is magnetically attracted by the aforementioned stator 11.

After the motor shaft 6 is axially supported by the oil-retaining sintered metal bearing 5 and the radial ball bearing 20 in the above-described manner, a retaining ring 14 is set in a groove portion of the motor shaft 6, thereby completing the assembly.

According to the motor completed as described above, since the motor shaft 6 is axially supported properly without run-out, it is confirmed that the motor can be started reliably even in cases where there is a variation in the state of energization of the coil 9 during starting and the energization is hence effected at a slightly lower level.

### Second Embodiment

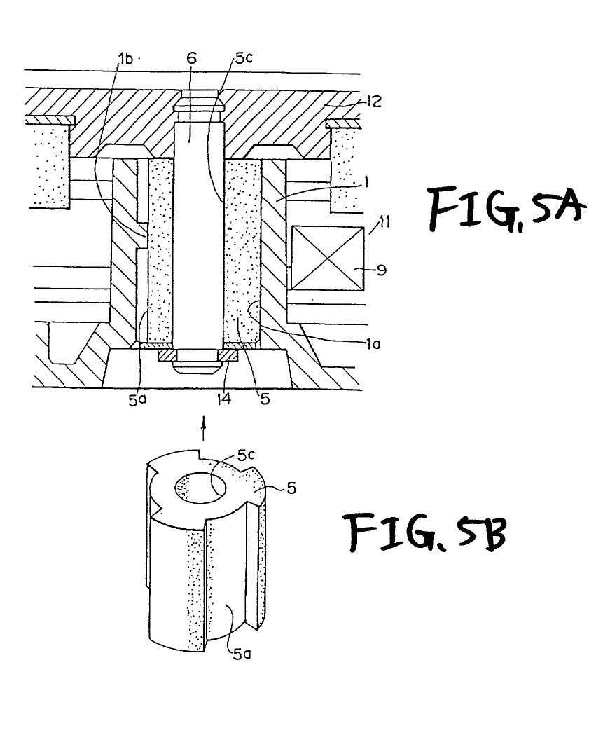

FIG. 5A is a central cross-sectional view of a second embodiment in a case where the bearing housing is applied to a brushless axial fan motor. FIG. 5B is an exploded view of component parts.

In the drawings, the component parts which have already been described are denoted by the same reference numerals, and a description thereof will be omitted. As shown, only the oil-retaining sintered metal bearing 5 is provided in the bearing hole portion 1a. In FIG. 5B, three recessed portions 5a for escaping from the stepped portions 1b are formed in this oil-retaining sintered metal bearing 5. A bearing hole portion 5c having a sufficient depth and extending along the longitudinal direction of the motor shaft 6 is formed in the metal bearing 5, and the motor shaft 6 is prevented from skewing and can be axially supported by a single metal bearing 5.

It should be noted that although in the above-described two embodiments a description has been given of only the brushless axial fan motor, the invention is not limited to the same, and it goes without saying that the invention is applicable to motors of various usages. In addition, the number of stepped portions molded is not limited to three, and it suffices if at least two stepped portions are provided. In the case of a large-size model, it suffices if the number of stepped portions molded is increased.

As described above, in accordance with the invention, it is possible to provide a method of molding a bearing housing which makes it possible to support a bearing at the same inner peripheral surface in a bearing hole portion of the bearing housing by ensuring coaxiality of an injection mold when bearings are inserted and fixed in a state in which stepped portions formed midway on the bearing hole portion are interposed therebetween, as well as a motor using the bearing housing.

What is claimed is:

1. A method of molding a bearing housing, for axially supporting a motor rotor, having stepped portions midway on an inner peripheral surface of a bearing hole portion, wherein the bearing housing is injection molded from a predetermined resin material, the method comprising the steps of:
providing in a first mold block a first cavity portion for molding a first inner peripheral surface which is molded continuously from an opening of the beating hole portion;
providing in a second mold block a second cavity portion and a plurality of shape portions, for forming the stepped portions, each of which has an outside diameter greater than an inside diameter of the first inner peripheral surface and extends toward the first mold block, wherein the first cavity portion and the second cavity portion forming a cavity at the time of mold closing is coaxially positioned; and
introducing the predetermined resin material in a molten state into the cavity to effect molding.

2. A motor having a bearing housing obtained by a method as claimed in claim 1.

3. The motor according to claim 2, wherein
at least one of a metal bearing and a radial ball bearing is supported by the plurality of stepped portions.

4. The motor according to claim 3, wherein the stepped portion supports both of the metal beating and the ball bearing.

5. The motor according to claim 3, wherein the metal bearing is provided with a recessed portion for escaping from the stepped portion.

6. The motor according to claim 4, wherein the metal bearing is an oil-retaining sintered metal bearing.

7. A mold for molding a bearing housing, for axially supporting a motor rotor, having stepped portions molded midway on an inner peripheral surface of a bearing hole portion, wherein the beading housing is injection molded from a predetermined resin material, the mold comprising:
a first mold block provided with a first cavity portion for molding a first inner peripheral surface which is molded continuously from an opening of the bearing hole portion; and
a second mold block provided with a second cavity portion and a plurality of shape portions, for forming the stepped portions, each of which has an outside diameter greater than an inside diameter of the first inner peripheral surface and extends toward the first mold block,
wherein the first cavity portion and the second cavity portion forming a cavity at the time of mold closing is coaxially positioned.

8. A motor comprising:
at least one bearing for supporting a motor shaft of a motor rotor;
a housing provided with a bearing hole portion into which the bearing is inserted; and
a stepped portion, for supporting the at least one bearing, which is provided at a part of the inner circumference of the bearing hole portion and has a diameter smaller than an inner diameter of the bearing hole portion.
